(19) United States
(12) Patent Application Publication
(10) Pub. No.: US 2013/0275258 A1
(43) Pub. Date: Oct. 17, 2013

(54) System, Method, and Computer-readable program for managing cost and supply of parts

(71) Applicant: Akoya, Inc., Naperville, IL (US)

(72) Inventors: J. Alan Stacklin, Naperville, IL (US); Stephen G. Eick, Naperville, IL (US); Brett Holland, Chicago, IL (US)

(21) Appl. No.: 13/915,945

(22) Filed: Jun. 12, 2013

Related U.S. Application Data
(63) Continuation-in-part of application No. 12/945,696, filed on Nov. 12, 2010.
Application No. 12/945,696 is a division of application No. 11/372,937, filed on Mar. 9, 2006, now abandoned.
(60) Provisional application No. 60/659,992, filed on Mar. 9, 2005.
(60) Provisional application No. 61/658,532, filed on Jun. 12, 2012.

(51) Int. Cl. G06Q 30/06

(52) U.S. Cl. CPC G06Q 30/0621
USPC 705/26.5

(57) ABSTRACT

System, method, and computer-readable program for managing cost and supply of parts are disclosed. According to one embodiment of the disclosure, a computerized method of managing cost and supply of parts includes receiving part information for a plurality of part suppliers, wherein the part information for each part supplier comprises material data of parts, and receiving a request involving the material data of parts of the plurality of part suppliers. The computerized method also includes automatically determining any relevant material data of parts of the plurality of part suppliers based on the request and displaying at least a portion of the relevant material data.

### CROSS REFERENCE TO RELATED APPLICATION

This U.S. patent application is a continuation-in-part application of and claims the priority benefit of U.S. Nonprovisional patent application Ser. No. 12/945,696, filed Nov. 12, 2010, which is a U.S. divisional patent application of and claims the priority benefit of U.S. Nonprovisional patent application Ser. No. 11/372,937, filed Mar. 9, 2006, which claims the benefit of and incorporates by reference herein the disclosure of U.S. Provisional Patent Application Ser. No. 60/659,992, filed Mar. 9, 2005.

This U.S. patent application also claims the benefit of and incorporates by reference herein the disclosure of U.S. Ser. No. 61/658,532, filed Jun. 12, 2012.

### BACKGROUND

Commercial producers of equipment, machines, and other products that require numerous parts often obtain parts from a variety of different part suppliers. It is crucial to the survival of each producer's business that the producer's suppliers be able to consistently provide the parts at an acceptable price. Because of this reliance, it comes as no surprise that information regarding the vulnerability and cost effectiveness of a part supplier is extremely valuable. In the past, producers have depended upon personal relationships with a part supplier and discussions with others in the industry to determine the level of vulnerability and cost effectiveness of a particular part supplier. While this word-of-mouth system may have been helpful in some limited circumstances, the world-wide nature of part supply today makes such a system unworkable. Besides, such a system largely depends on the trust of other individuals who may have a motivation to bend the truth to their advantage. Thus, the system itself is inherently flawed. Accordingly, there exists a need for a system, method, and computer-readable program that allows producers to manage the cost and supply of parts, such as by determining which supplier makes the best parts, determining an alternative material to use for certain parts, and/or determining which material may be more cost effective in making certain parts.

### SUMMARY

The present disclosure discloses a system, method, and computer-readable program for managing cost and supply of parts. In at least one embodiment of the present disclosure, a computerized method of managing cost and supply of parts includes receiving part information for a plurality of part suppliers, wherein the part information for each part supplier comprises material data of parts, receiving a request involving the material data of parts of the plurality of part suppliers, automatically determining any relevant material data of parts of the plurality of part suppliers based on the request, and displaying at least a portion of the relevant material data.

In at least one embodiment of the present disclosure, a computerized method of managing cost and supply of parts includes collecting part information for one or more part buyers, wherein the part information for each part buyer comprises material data of parts of the part buyer, receiving a request involving the material data of the one or more part buyers, automatically determining any relevant material data of the part information for the one or more part buyers, and displaying at least a portion of the relevant material data for the one or more part buyers.

In at least one embodiment of the present disclosure, a system of managing cost and supply of parts includes a database comprising part information for a plurality of part suppliers and one or more part buyers, wherein the part information comprises material data of parts, and a processor operably connected to the database, wherein the processor receives requests, automatically determines any relevant material data based on the requests, and is configured to display the relevant material data on a monitor that is operably connected to the processor.

### BRIEF DESCRIPTION OF THE DRAWINGS

The features and advantages of this disclosure, and the manner of attaining them, will be more apparent and better understood by reference to the following descriptions of the disclosed system, method, and computer-readable program, taken in conjunction with the accompanying drawings, wherein:

FIG. 1 illustrates an overview of one embodiment of the invention;

FIGS. 2a-d comprise process modeling diagrams of the present invention;

FIG. 2e describes the assembly of FIGS. 2a-d to illustrate the process modeling diagram;

FIG. 3A illustrates one embodiment of the analytics layer;

FIG. 3B illustrates one method of sourcing analysis;

FIG. 3C illustrates one embodiment of the system architecture;

FIG. 3D illustrates the logical flow of a user's progression in the embodiment;

FIG. 4 illustrates the select parts by similar feature;

FIG. 5 illustrates the select parts by specific features;

FIG. 6 illustrates the cost savings opportunities summary;

FIG. 7 illustrates the select parts by category;

FIG. 8 illustrates the review parts for analysis in the analytics layer;

FIG. 9 illustrates the computations made during the analytics layer;

FIG. 10 illustrates the detailed parts analysis of a part;

FIG. 11 illustrates the cost drivers for a family of parts;

FIG. 12 illustrates a graphical representation of the cost drivers for a family of parts;

FIG. 13 illustrates the nearest neighbor analysis;

FIG. 14 illustrates the results sourcing analysis.

FIG. 15a shows a flowchart of a method for managing cost and supply of parts according to at least one embodiment of the present disclosure.

FIG. 15b shows a flowchart of a method for managing cost and supply of parts according to at least one embodiment of the present disclosure.

FIG. 15c shows a system for managing cost and supply of parts according to at least one embodiment of the present disclosure.

FIGS. 16-21 illustrate a graphical user interface of a computer-readable program for managing cost and supply of parts according to at least one embodiment of the present disclosure.

FIGS. 22a-22c illustrate an example of how the CSM tool may be used to eliminate materials for a company's portfolio.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

For purposes of illustration, the invention relates to a system and software product directed to an analytical methodology for cost management of highly engineered made-to-order parts. In one embodiment, the system takes data from computer assisted drawings (CAD) files, engineering specifications files, demand data from Enterprise Resource Planning (ERP) systems, cost data from financial systems, and/or other electronic files and utilizes data mining algorithms to analyze part features, usage patterns, and engineering specifications to construct “should cost” curves across individual families of parts. Based on the should cost curves, the embodiment determine the significant cost drivers that affect the cost of the one or more target parts.

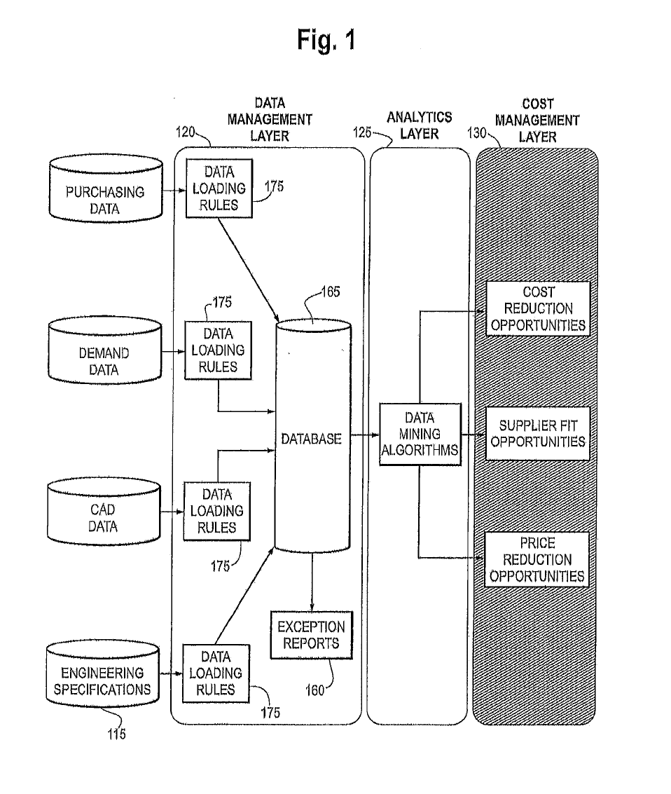

As best seen in FIG. 1, in one embodiment the system architecture consists of three distinct layers: the data management layer 120, the analytics layer 125, and the cost management layer 130. The data management layer 120 in the system architecture loads and manages customer data. The middle layer in the architecture is the analytics layer 130, which hosts various analysis algorithms that are required for invention models. The cost management layer 130 of the system architecture presents results in easy to understand and act-upon Cost Management Tools. In one embodiment, the cost management tools are presented to the user in a browser interface.

I. System Data Management Layer

In one embodiment of the system, the data management layer 120 consists of five parts. First, the system implements integration points that enable it to assimilate purchasing, financial, and part features information from the customer's internal systems. Within the integration points are data loading rules 175 the system uses as part of its data assimilation process. The reason for the data loading rules 175 is that each customer stores its parts purchasing and financial data using different formats. The data loading rules 175 aggregate data various customers and thereby enable the system to employ a business intelligence “should cost” database 165 that is reusable across customers.

The part features extraction process involves two types of information. The first type includes engineering specifications' 115 that describe physical characteristics of the part. By processing these files the system can extract a set of physical features that describe the part. Examples of these features include material, e.g., which metal, height, width, and depth of the part, physical volume, number of cores, and characteristics of the drill holes. The second type of information involves machining specifications such as tolerances, smoothness, drill holes, drill hole volume, and parting line perimeter. There is a set of engineering specifications associated with each part. As a component of the feature extraction process, the system processes each specification and extracts relevant information for cost modeling.

Second, using the data loading rules 175, the system data loading tools transform, normalize and validate parts data as it is stored in the database 165. In one embodiment, the data loading rules 175 are written in the R statistical language.

Third, the system employs exception reports 160 that highlight unusual and suspect information. The reports, for example, identify unusually expensive parts or cheap parts, parts with missing weights, parts with no demand, suppliers, and many other characteristics of the data.

Fourth, the system analyzes 2D parts drawings and 3D engineering models of the parts and extracts features that are predictive of costs. In one embodiment, cost predictive features variables include financial information, purchasing information, and feature information. As best seen in TABLE 1, the features may involve part characteristics such as the volume of the part, which along with the density of the material, is used to calculate the part's weight, number of holes drilled into the part, type of drill used, number of cores, number of risers, surfaces, machine setups, and the like. One of ordinary skill in the art will appreciate that this table does not provide an exhaustive list, but is merely illustrative. The features characteristics are the primary drivers that enable the system's predictive models to achieve high accuracy.

TABLE 1
Cost Predictive Features Variables

| Financial | Purchasing | Feature |
|---|---|---|
| Information | Information | Information |
| Part Number | Segment | Material |

| | | |
|---|---|---|
| Part Name | Family | Aluminum |
| Engineering Change | Class | Brass |
| Number | | |
| Forecasted Annual | Supplier | Ductile Iron |
| Demand | | |
| Demand Past 12 | Buyer | Gray Iron |
| Months | | |
| Base Part Price | Finishes Status | Malleable Iron |
| | (Rough, Semi, | |
| | Finished) | |
| Additional Charges | Part Weight | Steel |

| | | |
|---|---|---|
| Packaging | Quoted Annual | Casting Cost |
| | Demand | |
| Painting | Quote Date | Part Dimensions |
| (Prime/Finish) | | |

| | |
|---|---|
| Other | Height |
| Material Surcharge | Width |
| Export Charges | Depth |
| Storage/Warehousing | Surface Area |
| Tooling | Part Volume |
| Premium Charge | Box Volume |
| | Finished Weight |

Part Features

Cores
Core Volume
Pressure test - Air
Pressure test - Fuel
Pressure test - Oil
Pressure test - Water

Machining Cost

Direct

Ports
Port Volume
Drill Holes
Drill Hole Volume
Heat Treat
Parting Line Perimeter
Grinding
Machine Setups
Riser Removal
Surface Area Flatness

Indirect

Forecasted Annual
Demand
Log Annual Demand

Assembly Cost

Direct

Bearings
Fasteners
Seals

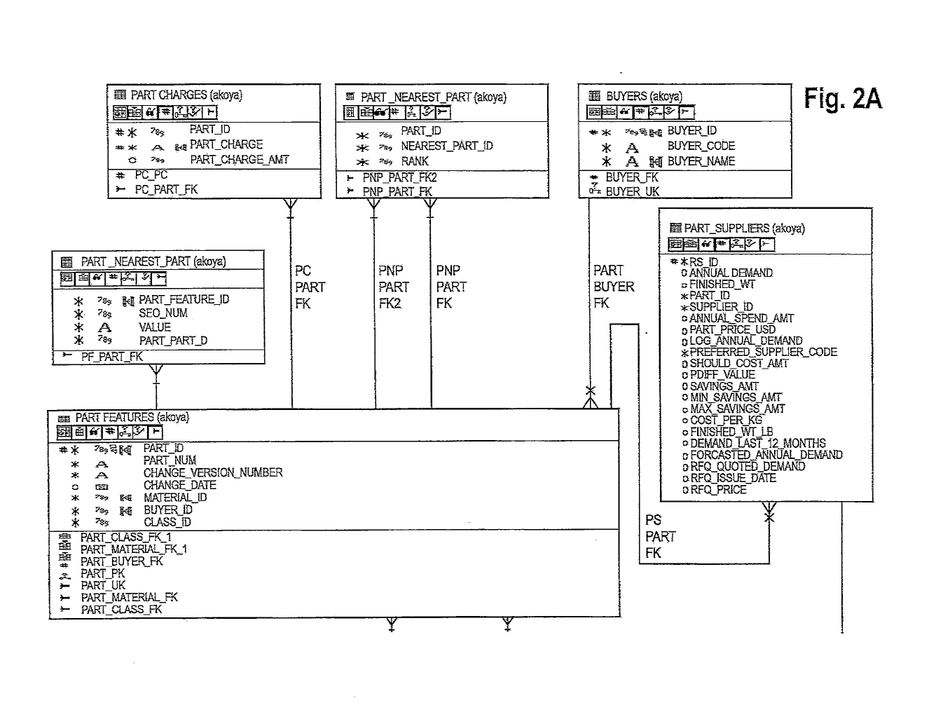

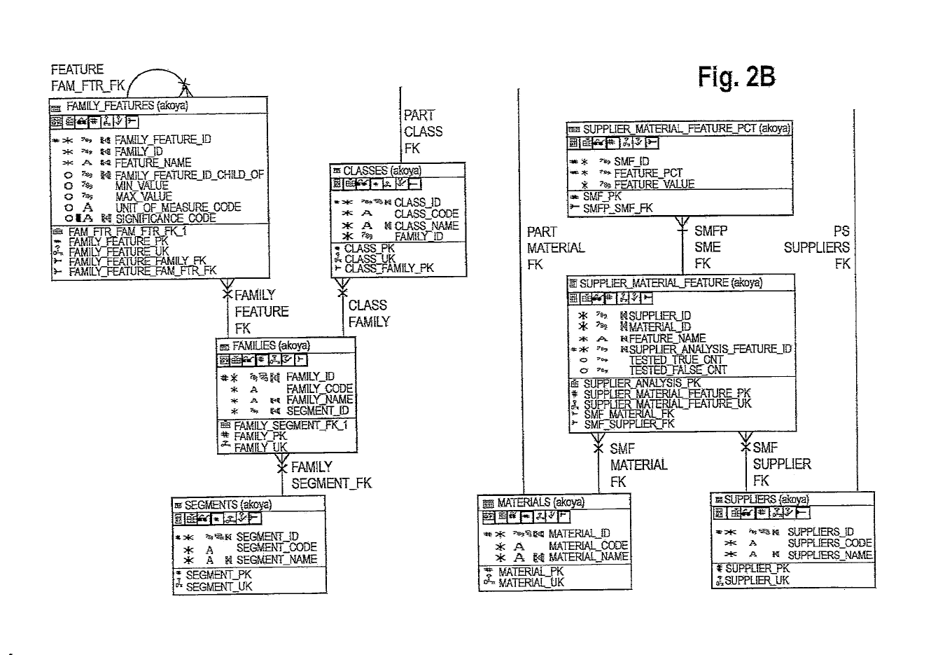

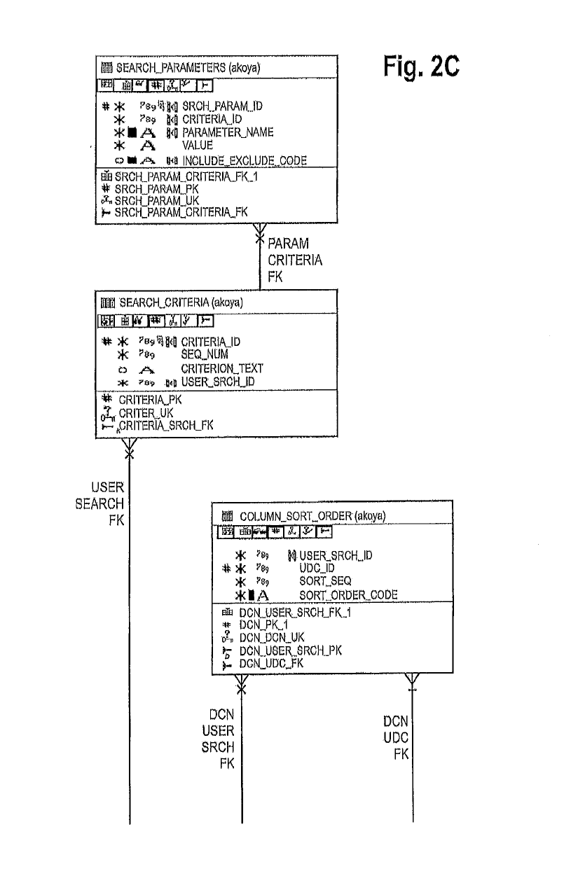

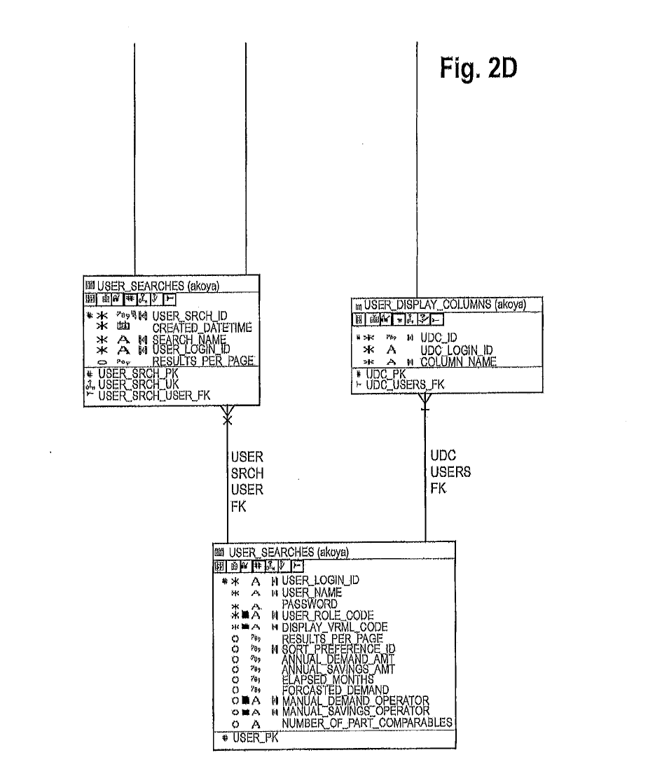

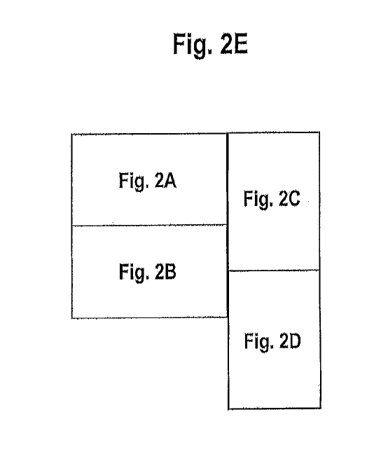

The fifth part of the system's data management layer is the database 165. In one embodiment, the system organizes parts data using snowflake schema data warehouse model with fact tables for parts and suppliers. An embodiment of the snowflake database schema is shown in FIG. 2a-2e. One of ordinary skill in the art will appreciate the snowflake schema is but one architecture of a data warehouse, and other schemas, including but not limited to a star schema, may be used.

It should be appreciated that part of this invention relates to choices of variables which may be loaded and data loading rules 175 used to process the data. There are many possible features that can be extracted from CAD data and many possible purchasing and demand variables. One aspect of the invention is the selection of variables and modeling techniques that are predictive of cost.

1. Data Management Architecture

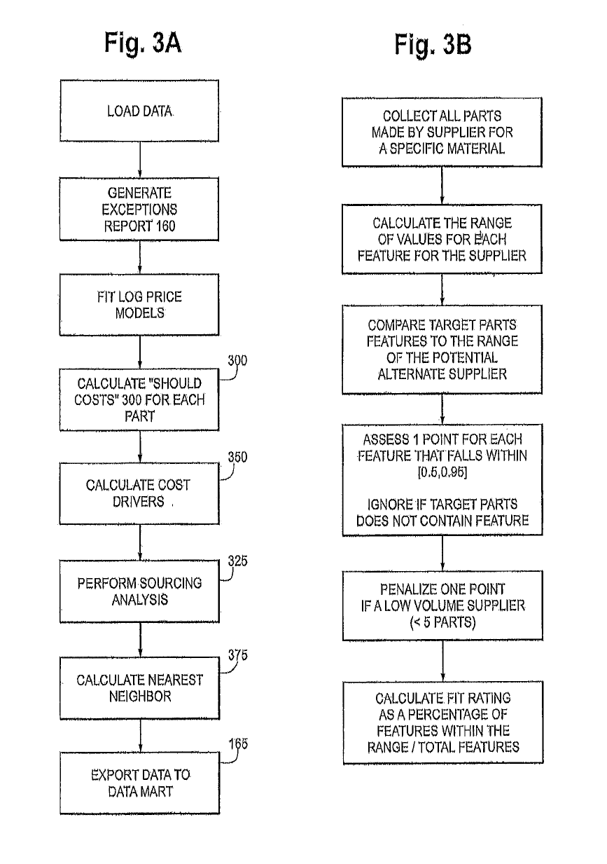

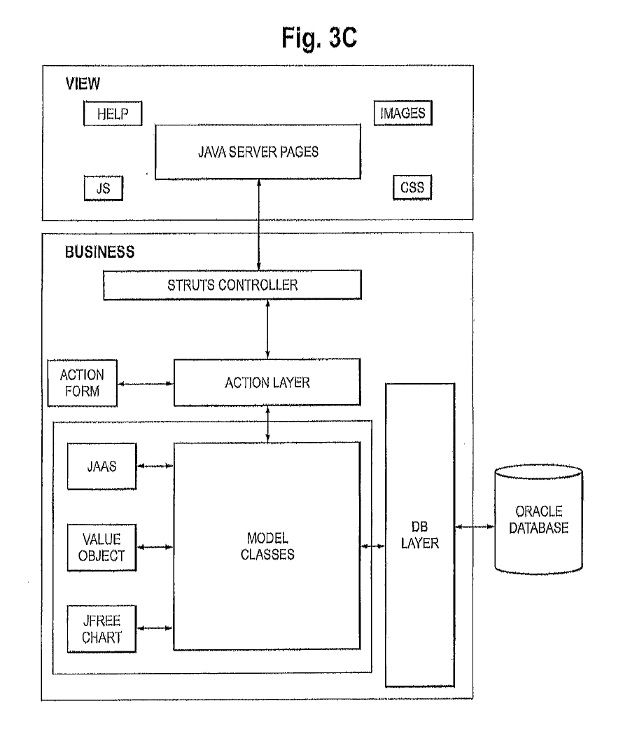

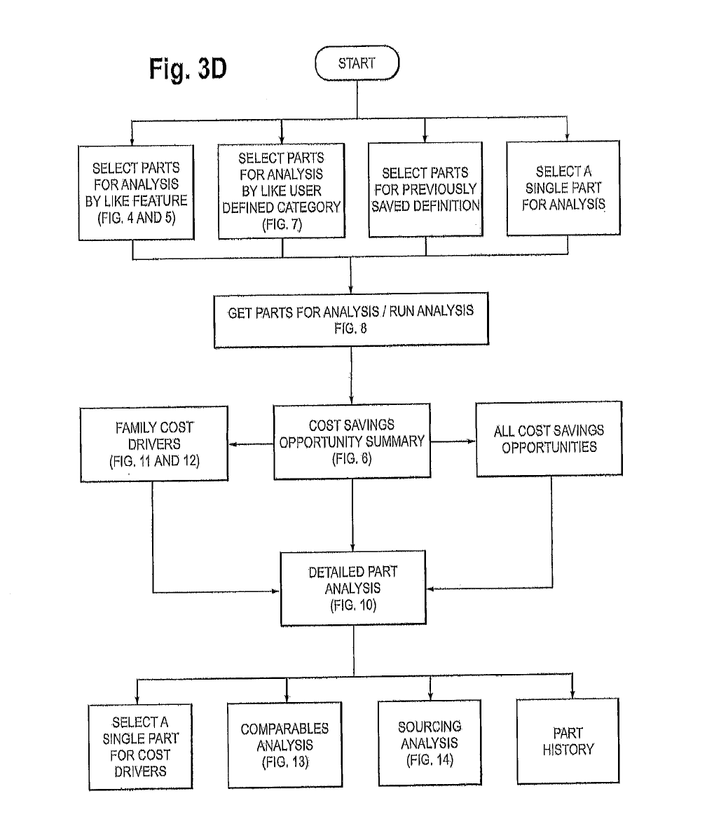

At the architectural level, one embodiment of the system performs data management functions using a four-step process, as best seen in FIG. 3A. In this embodiment, the data management process is performed as follows:

First, in one embodiment, the system extracts the data from the customer delivered formats and loads the files into memory. Next, the system aggregates, categorizes and filters the data based on customer defined rules. At this point, the system performs extreme value elimination by applying the data loading rules 175 and looking for extreme statistical values. The parts associated with the extreme values are eliminated from the data set under consideration. The system then takes the data from step 2 and loads it into database 165 for analysis. If a part is excluded from loading, the system will generate exception reports 160 which provide the user with information on any data load failures or exceptions. Once the data is properly loaded into the database 165, the analytics layer 120 performs model fitting algorithm analysis.

II. Analytics Layer

The second layer of the system's architecture is the analytics layer 125. This analytics layer 125 consists of a 20 series of statistical routines that, in one embodiment, are implemented using the R Statistical Language. Further, this analytics layer 125 in the disclosed embodiment comprises two parts: the analytics module and analytics architecture.

A. Analytic Modules

As part of its analytical layer 125, an embodiment of the system performs four primary calculations. First, based on part features, material, manufacturing processes, and purchasing demand volumes, the should cost 300 module of the analytics layer 120 calculates a “should cost” price for each part. For purposes of illustration, “should cost” refers to the amount of money a part should reasonably cost. In this embodiment, the system identifies outliers by comparing the “should cost” with the vendor's quoted price. Outliers refers to parts which seem to be unusually expensive compared with what the model predicts that they should cost. Second, the cost drivers 350 module of the analytic layer 125 identifies key factors called “cost drivers,” which contribute to part costs. These key factors can be used by the engineering staff to minimize costs in the design process. Third, the nearest neighbor 375 module identifies similar parts called “nearest neighbors.” Last, the sourcing analysis 325 module of the analytics layer 125 analyzes the capabilities of the suppliers to identify their core capabilities and thereby determines which parts are most efficiently sourced which each respective supplier.

1. Should Cost—Predicting What Each Part Should Reasonably Cost

The should cost 300 module models the costs of parts by predicting the price/kg for each part using generalized linear models.

a. Linear Combination Algorithm—Predicting the Price/kg

This algorithm predicts the log of the cost per kilogram of a part using a linear combination of features and categories.
Log (costperkg)˜transform (dmd)+finwt.kg*material+boxvol+height+width+depth+risers*material+drillholeComp*material+surfarea*material+partingLinePerim*material+factor(hasCores)+nCores+factor(nCores)+coreVol+sqrt(coreVol)+sqrt(nCores)+factor(nCores)+heatTreat+sqrt(pressTestAir)+sqrt(pressTestOil)+sqrt(pres sTestWater)+sqrt(pres sTestFuel)+sqrt(drillholes)*material+nPorts+factor(rsf)+class.desc+nBearings+nSeal+NFasteners)+factor (material)

What should be appreciated is that our model does not predict “should cost” directly. Instead, for each family of parts, the algorithm predicts the log of cost per kilogram as a linear function of the log of the annual demand for parts, physical features of the part, machining costs, and engineering specifications. The type of material, which the model includes as a variable, is also important. The predicted “should cost” price is then the exponential of the predicted log cost per kilogram of the part.

In one embodiment of the system, models of this form are developed for all of the parts together and then again for each family of parts (e.g., Bonnets, Brackets, Covers, Housings, Elbows, and Supports). After the full model is fit, the embodiment refines its models using R's step procedure. In this embodiment, step applies the stepAlC algorithm. In this embodiment, the algorithm refines the model, adds and removes variables, and iterates until it finds the best fit. It will be appreciated by one skilled in the art that other refinement procedures may be used and that the above described embodiment is not exclusive but merely illustrative.

2. Cost Drivers

In one embodiment, the cost driver 350 module identifies outliers by comparing the “should cost” with the vendor's quoted price. After outliers are eliminated, in a similar calculation to “should cost,” the cost drivers for a family of parts are predicted using a linear combination of features and categories. The system models the cost per kilogram of each part as:
Costperkg˜finwt.kg (alum, duct, brass, iron, gray, steel)+boxvol+height+width+depth+risers+drillholes+drillHoleComp+surfarea+partingLinePerim+nCores+coreVol+heatTreat+factor (pressTestAir)+factor(pressTestWater)+factor (pressTestfuel)+factor (pressTestOil)+nBearings+nSeals+nFasteners+nPortS, +portVol, +flatness+log(demand)

²John M. Chambers and Trevor J. Hastie (1992). Statistical Models in S, Wadsworth & Brooks/Cole Cole Computer Science Series, Pacific Grove, Calif.

What should be appreciated is that our model does not predict “cost drivers” directly. Instead, for each family of parts it predicts the cost per kilogram as a linear function of the log of the annual demand for parts, features that describe the part, machining costs, and engineering specifications. The type of material, which the model includes as an interaction term, is also important. The predicted “cost driver” price is then the exponential of the predicted log cost per kilogram of the part. In one embodiment, models of this form are developed for all of the parts together and then again for each family of parts (e.g., Bonnets, Brackets, Covers, Housings, Elbows, and 20 Supports).

In one embodiment of the system, most predictive factors (cost drivers) and their relative effects are easy to interpret. FIG. 9 shows sample output from the system's Prediction Model. For the example illustrated in FIG. 9, certain key variables in the Model are marked with symbols, such as “***”, “**”, or “*”, to indicate their level of significance in the cost driver significance 900 column. In an embodiment of this particular model (model of a direct materials part analysis), the key variables for predicting costs include log (annual demand), box volume, part volume, drill holes, part type, material, and type of pressure test.

The relative effects of cost drivers for this example are shown in Table 2. The units in the table are incremental costs measured in cents per unit change in the cost driver. Thus, for example, on average a 10× increase in demand (logdmd) (1× in log scale) decreases the cost per kilogram of a part by $1.99.

TABLE 2
Cost Drivers and their relative effects in cents.

| | Incremental costs (¢/unit |
|---|---|
| Cost Drivers (CD) | change in CD) |
| Logdmd | −199.87 |
| Boxvol | 1.08 |
| Height | −.69 |
| Width | −.91 |
| Depth | −.50 |
| Partvol | −7.56e−5 |
| Drillholes | 9.80 |
| CoreVol | 7.54 |
| factor (class.desc) BONNETS | −24.20 |
| factor (class.desc)BRACKETS | −217.95 |
| factor (class.desc) COVERS | −333.12 |
| factor (class.desc) ELBOWS A | 229.05 |
| factor (class.desc) HOUSINGS | 297.75 |
| factor (class.desc) SUPPORTS- | −121.31 |
| ENGINE | |
| factor (heatTreat) Yes | −824.10 |
| factor (pressTestVal) Air | 129.85 |
| factor (pressTestVal) Fuel | 1767.42 |
| factor(pressTestVal)Oil | 332.38 |
| factor(pressTestVal)Unknown | −320.61 |
| factor(pressTestVal)Water | −24.93 |
| factor(material.coarse)DUCT | −1233.37 |
| factor(material.coarse)GRAY | −1366.98 |
| factor(material.coarse)IRON | −1090.80 |
| factor(material.coarse)STLCAST | −359.44 |

It should be appreciated from linear regression theory that the parameters in Table 2 are the cost drivers that are displayed in the system's Cost Management Analysis (CMA) user interface.

These parameters estimate the incremental costs for each of the features included in the model. In one embodiment of the system, these features are validated by applying the business rules (are these the data loading business rules?). It is sometimes the case that randomness in the statistical models results in aberrant estimates. The business rules flag suspect values and provide explanations such as insufficient data in the case of extreme randomness.

3. Nearest Neighbor Algorithm—Identifying Similar Parts

The second class of system algorithms involves searching feature space to identify similar parts or nearest neighbors. In one embodiment, calculation of data structures subsequently applied to produce predictions and used in the nearest neighbor analysis is performed at data loading time or whenever new data is added to the system's database. The system uses pre-determined variables as feature vector and defines these vectors as a point in feature space:

vᵢ=(v₁, v₂, . . . ,vₙ)

where vᵢ is the value of feature i for the particular part under consideration. Table 3 shows a list of variables used in one embodiment of the nearest neighbor analysis. It should be obvious to one of ordinary skill in the art that the table is meant to be only illustrative and not exclusive. The system then normalizes each of the numeric features using the standard normal transform and in one embodiment calculates the Euclidean distance (d) between the points representing the different parts in feature space. One of skill in the art will appreciate that other distance metrics, besides the Euclidean, may be used.

d(v_{part1,}vₚₐᵣₜ₂)=II vₚₐᵣₜ₁−vₚₐᵣₜ₂II

where II II is the standard Euclidean distance function.

When the user selects a target part, pre-selected feature variables of that part become reference points and the system then provides the distance between those target variables and all other parts. The nearest neighbor algorithm constrains the match so that certain attributes of the parts must match exactly, e.g., the parts must be made of the same material and be the same part type. Within this restricted class it enumerates all distances and returns the n candidates to the user interface.

TABLE 3
Variables for Nearest Neighbor analysis

| Comparables Analysis | Comparables Analysis |
|---|---|
| Variable | Variable Definition |
| Finwt | finished weight |
| height | height dimension |
| Width | width dimension |
| Depth | depth dimension |
| partvol | part volume dimensions |
| Surfacea | surface area dimension |
| partingLinePerim | parting line perimeter grinding |
| Risers | risers (removal) |
| Drillholes | number of drill holes |
| Nports | number of ports |
| HeatTreat | heat treat of part |
| PressTestAir | pressure test air |
| PressTestFuel | Pressure test fuel |
| PressTestOil | pressure test oil |
| PressTestWater | pressure test water |
| NCores | number of cores |

4. Sourcing Analysis—Evaluating the Suppliers

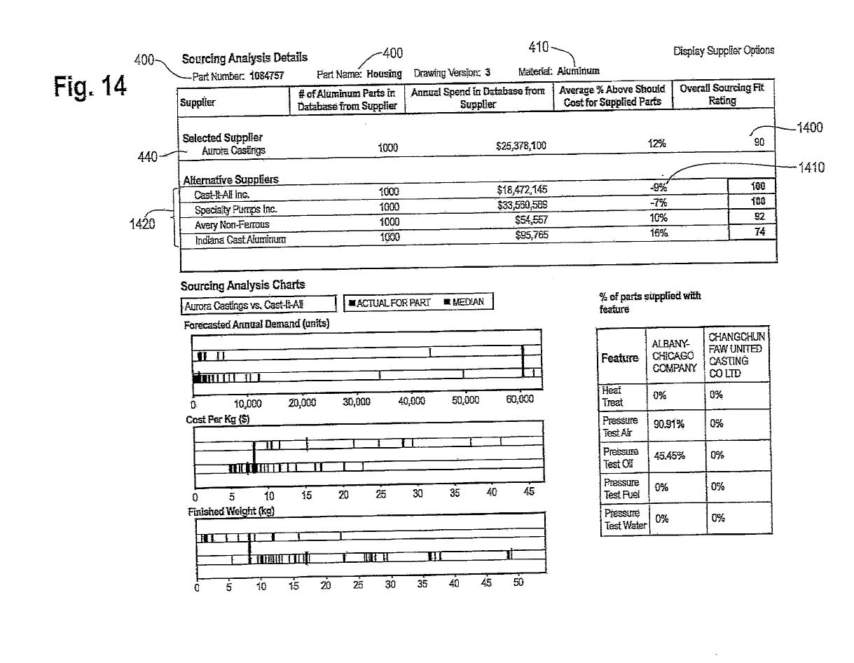

One possible reason for an overpriced part may be because it is sourced with a supplier who cannot produce it efficiently. For each part the system rates each supplier on an Overall Sourcing Fit Rating 1400 (See FIG. 14). An Overall Sourcing Fit Rating 1400 is calculated for each supplier by determining how far the target part is away from the range of efficiency for each supplier for each of the different part source variable categories, including but not limited to the variables listed in TABLE 4. One of ordinary skill in the art will appreciate that the table is meant to be only illustrative, and not exclusive. If the overall sourcing fit rating 1400 is low, it suggests that perhaps another source might be more appropriate for this part.

TABLE 4
FEATURE VARIABLES FOR OVERALL SOURCE FIT RATING
Feature Variables for Overall Sourcing Fit Rating

Cost per Kg
Annual Demand
Finwt/kg
Height
box volume
Surface area dimension
heat treated
Pressure Testing

Air
Fuel
Oil
Water

Average core volume
Average port volume
Average drill hole volume
Maximum flatness
is.assembly

The sourcing fit analysis works by analyzing the parts that each supplier produces, as shown in FIG. 313. The first step in the calculation is to collect all parts made by supplier for a specific material. Next the system calculates the range of values for all part source categories for each part for each supplier. The system then compares the part source categories for the target parts features to the range of the source part values of each potential supplier. The system assesses 1 point for each feature that falls within [0.5,0.95]. If the target parts does not contain the feature, the system ignores it. Further, the system penalizes one point in cases of a low volume supplier. Using this scoring rating, the system calculates fit rating as a percentage of features within the range/total features.

The score percentage displayed in the user interface is the Score(p)/number of features checked. For each part, the algorithm checks every possible supplier, sorts them in reverse order, and displays the best suppliers. Ties for suppliers that have the same percentage are broken by sorting on pdiff, the percentage difference between should cost and the actual price.

B. Analytics Architecture

At the architectural level, one embodiment of the system performs system analysis, as best seen in FIG. 3A.

Using all of the parts data in the system's populated database 165, in an off-line process, the system runs several statistical and data mining routines that fit models. The fitting process results in sets of models and coefficients that are used in subsequent analysis. In addition, the system pre-calculates many data structures that are subsequently applied to produce predictions and used in the nearest neighbor 375 module. As part of its off-line calculations, the system stores each part in the invention database for “cost reasonableness” and flags any unusual parts for further investigation. In one embodiment, model fitting and scoring are performed at data loading time or whenever new data is added to the system's database 165.

In this embodiment, as shown in FIG. 3A, the system analysis process is performed as follows:

Once the data is loaded into the database 165, as discussed above and shown in FIG. 3A, the system sequences the model fitting algorithms to ensure the proper fitting and results. Next, the system extracts data from the database 165 and loads that data into the analytical engine. The analytical engine then performs the following model fitting algorithms analysis based on input from the sequencer:

First, the system calculates the “should cost” price in the should cost 300 module. Here, for each part, in one embodiment, the system applies the log(costperkg) model from step 3 to predict the cost of each part. The predicted “should cost” value is compared with the vendor's price to identify large percentage differences, which one embodiment stores in a variable called pdiff. Parts with large positive pdiffs, e.g., a part is much more expensive than predicted, are candidates for cost savings. The should cost 300 module is described at length above.

Next, the system calculates “Cost Drivers” from the cost drivers 350 module. Here, for each part family, in one embodiment, the system uses the R statistical language to fit linear regression that predict should cost as a generalized linear function of the part's features. As with normal statistical theory, the coefficients in this model are the relative contributions of the particular features. The “cost driver” 350 module is described at length above.

Next, the system performs the “Nearest Neighbor” analysis in the nearest neighbor 375 module. Here, in one embodiment, for each part the system normalizes each feature to a (−1,1) scale and calculates the Euclidean distance between every part in feature space. Using this distance the system identifies the nearest parts and labels them neighbors. The nearest neighbor 375 module is described at length above.

Next, the system performs a Sourcing Analysis in the sourcing analysis 325 module. In one embodiment, this analysis involves analyzing every part in the dataset that each supplier produces and calculating the [0.5, 0.95] range of each feature. Then for each part the system, in one embodiment, scores each supplier on 16 possible features and give the supplier points each time the part's feature is in the [0.5, 0.95] range of the supplier's capability. The system also subtracts points in cases of a low volume supplier. The rating of a supplier for a part is its total score/number of features evaluated. The calculation is performed by material for each supplier. The sourcing analysis 325 module is described at length above. The last step involves pushing out the analytical results to a database 165. The CMA website then accesses the database 165 to provide information to CMA users. Users access the system's analytical routines, through the system's presentation layer, which is described below. A top level view of the CMA application architecture can be seen in FIG. 3C. For a description of the elements in the CMA application application, see LEGEND 1 below.

LEGEND 1: Elements in CMA application Architecture

View
Java Server Pages—Jave Pages for UI
JS Javascript
CSS—Cascading Style Sheets for web pages
Images—Images for web pages
Help—Third party help system
Business
Struts Controller—Part of the Apache Framework
Action layer—Part of the Apache Framework
Action Form—Unique forms for defining the actions of the
action layer
JAAS—Java Authentication and Authorization Service
Value Objects—Objects used to define business rules
JFREE Chart—Third party charting object
Model Classes—Classes to interface between the action
layer and the database layer
DB Layer—Interface layer to the database

III. Cost Management Layer

The third layer of the system architecture is the cost management layer 130. The system's cost management layer 130 allows for the user to automatically group parts for analysis and provides a detailed analysis of cost saving opportunities.

A. Accessing the System

Users may access the system in one of three ways: (i) selecting parts by feature, (ii) selecting parts by category, or (iii) retrieving parts selected in previous analysis session. The logical flow of the cost management layer 130 is best represented by FIG. 3D.

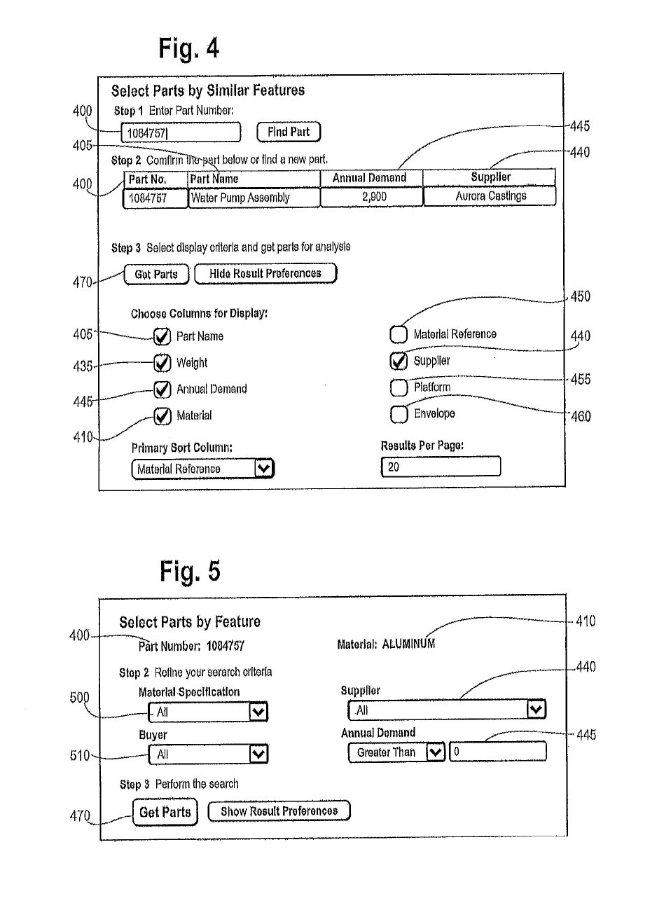

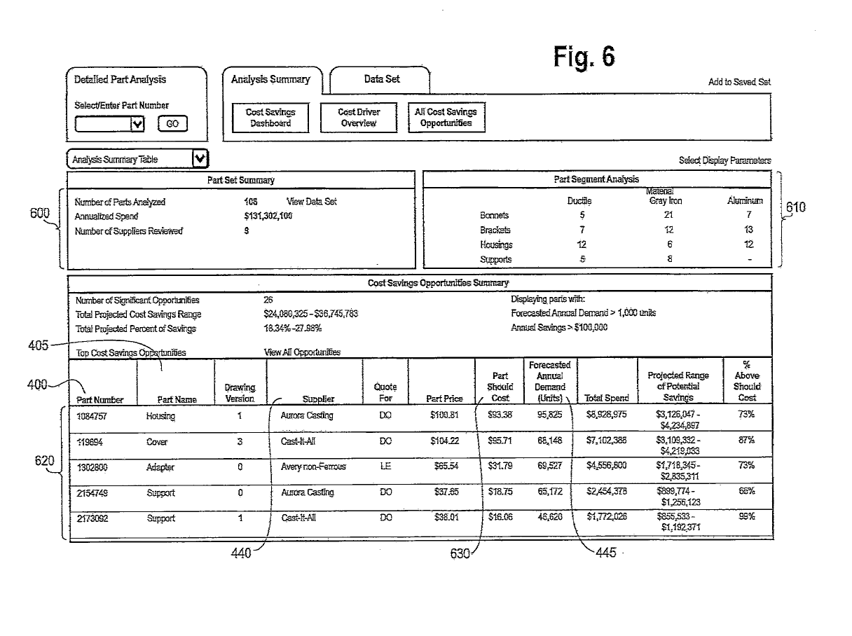

One way for the user to access the system is to search for parts by features, as best seen in FIG. 4. The user begins by inputting a part number 400 as a reference point. The embodiment then displays the part name 405, the part supplier 440, and the part annual demand 445. The user may then optionally select the columns for display such as the part name 405, the part weight 435, the part annual demand 445, the part material 410, the part material reference 450, the part supplier 440, the part platform 445, and the part envelope 4.60. The system will then use the nearest neighbor algorithm to find parts with similar features in the database to analyze and display the results. As best seen in FIG. 6, the search results display the part set summary 600, the part segment analysis 610, and the nearest neighbor list 620. The nearest neighbor list 620 set becomes the systems working set for this particular analysis.

In one embodiment of the system, as best seen in FIG. 5, the above-described search feature provides the user with the ability to refine the search criteria using several search filters including but not limited to part material 410, part buyer 520, part supplier 440 and part annual purchasing demand 445.

The second entry point to the system provides a Category Part Selector mechanism for specifying a system database search.

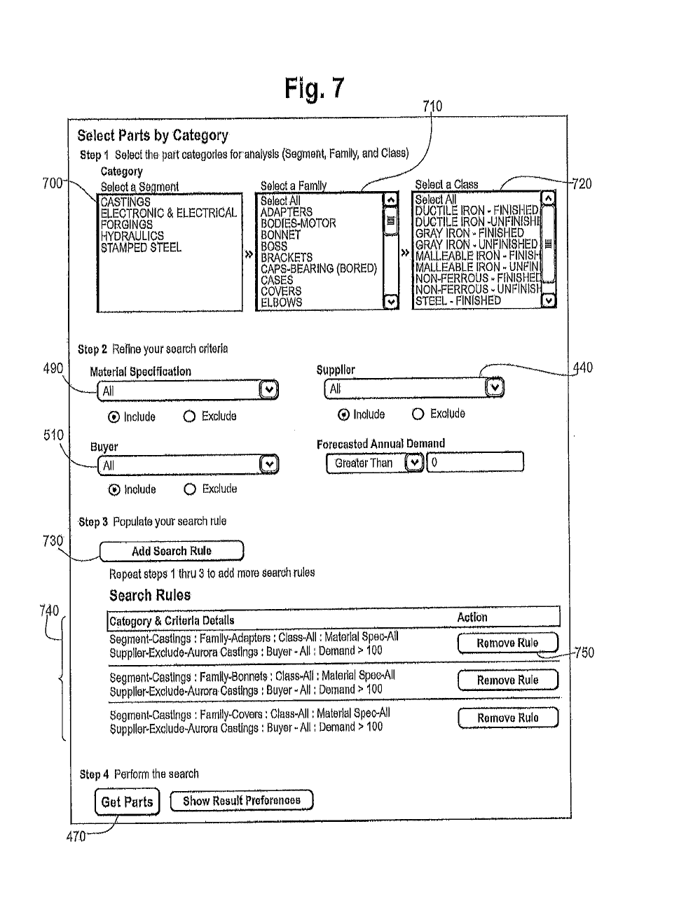

In one embodiment of the system, users can create search rules for category part searches. In this embodiment, system users may create rules by selecting parts segments 700, part families 710 and part classes 720 to include in the search rules as well as filters based on part material 410, part buyer 510, part supplier 440 and part annual purchasing demand 445. The search rule list 740 is displayed and the user may add a rule by engaging the add search 730 function. Optionally, the user may remove a rule by engaging the remove rule 740 function. One of ordinary skill in the art will appreciate that the categories for creating search rule listed above are not exhaustive but are merely illustrative of possible search criteria. The system will apply these rules to select parts from the system database for analysis. The Select Parts by Category mechanism is shown in FIG. 7. Pressing the get parts 470 function submits the working set of parts, as modified by the user, to the system's analytic engines, described above.

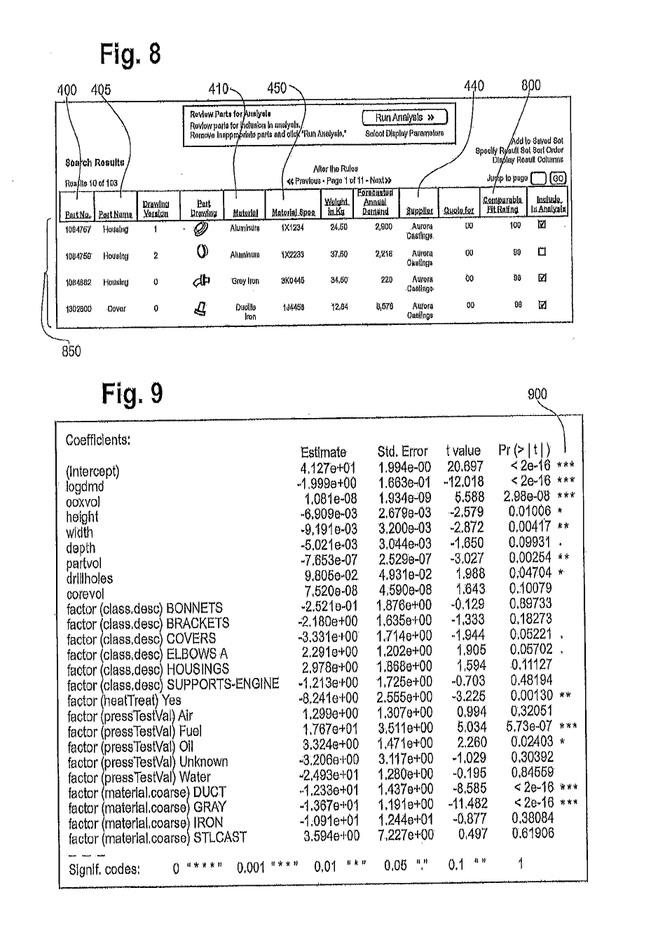

Third, users may review and “fine tune” their analysis working set using the dialogue shown in FIG. 8. In one embodiment, users may view their previous analysis set in a list 850 and then remove inappropriate parts or include additional parts in the analysis. Pressing the run analysis 875 function submits the working set of parts, as modified by the user, to the system's analytic engines, described above.

B. Cost Savings Opportunity Summary

Next, the system takes the results provided by the analytics layer 125 and presents the cost savings opportunities and their respective actions to the end user. For example, as can be seen in FIG. 6 the cost management layer 130 presents a top level summary of the parts analyzed. This includes a parts segment analysis 610, which lets the user know how the parts were segmented within the analysis and the top cost savings opportunities in order of potential savings. The analysis summary interface allows the user to access an overview of the cost drivers, and all cost savings opportunities, as well as access a detailed parts analysis for individual parts.

1. Detailed Part Analysis

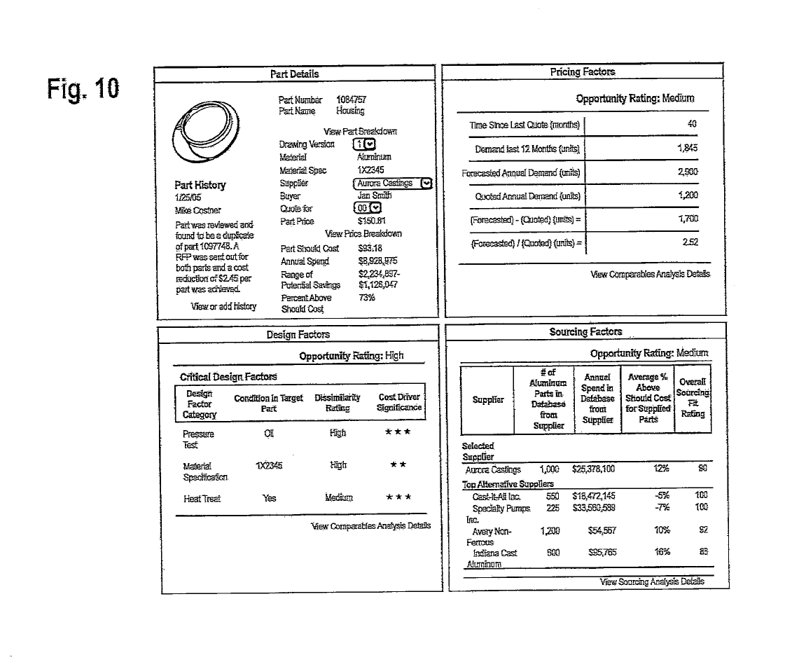

The system's detailed part analysis shows the details of the analytic layer 125 applied to a single part. The system shows the user what the part should cost as well as what the current part does cost and the potential savings based on the parts demand. In addition, a summary of how each of the cost factors (pricing, sourcing and design) are applied to that part. FIG. 10 shows an example report for a detailed part analysis on a single part. This report is broken into 4 quadrants, one that shows the part details including the calculated should cost, and the other three quadrants that display the cost factors related to pricing, sourcing and design. In one embodiment, the detailed parts analysis report allows the user to perform a comparables analysis, a sourcing analysis, and view the part's history.

2. Cost Driver Analysis:

The system Cost Driver Analysis provides the user with the cost model for a specific family of parts. This analysis details the costs associated with each of the parts parameters for a specific family of parts and shows graphically how the parts relate to each other.

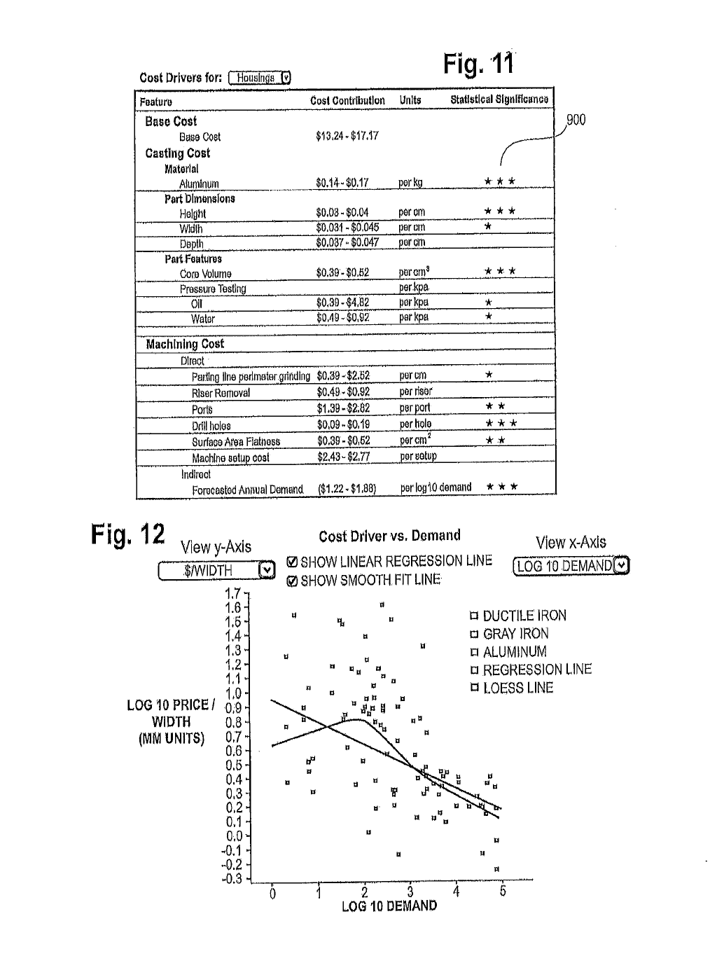

FIGS. 11 and 12 shows an example report for an invention Cost Driver Analysis on a family of parts.

3. Comparables Analysis

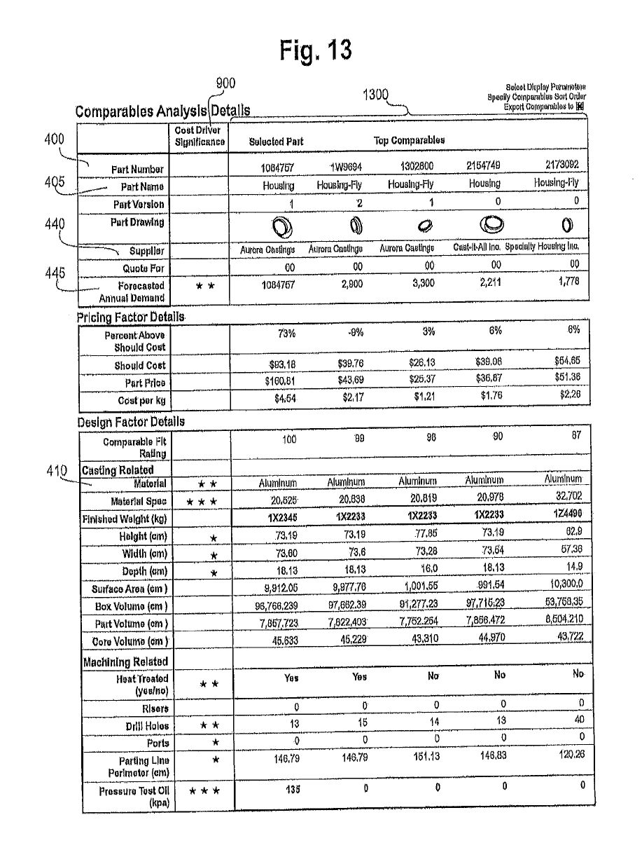

Referring now to TABLE 5, the nearest neighbor 375 module is used within the system to group parts based on like features (“comparables analysis”). This analysis is used when selecting parts by feature as well as when trying to find comparables to define redesign opportunities. The system nearest neighbor 375 module shows the users comparable parts as well as their characteristics. This analysis will show the user how similar parts are designed as well as provide the user with insight into design changes to the existing part that may reduce cost. FIG. 13 represents an example report for a nearest neighbor 375 module analysis for a single part.

TABLE 5

| partid | 2319329 | 2260299 | 2190628 | 2260302 | 2083729 | 1534212 |
|---|---|---|---|---|---|---|
| partname | HOUSING- | HOUSING- | HOUSING | HOUSING- | HOUSING | HOUSING |
| | FLYWHEEL | REAR | | FLY | | |
| costperkg | 38.83553 | 29.72777 | 5.697382 | 3.888642 | 5.521958 | 10.07332 |
| clssdesc | HOUSINGS | HOUSINGS | HOUSINGS | HOUSINGS | HOUSINGS | HOUSINGS |
| material.coarse | GRAY | GRAY | GRAY | GRAY | GRAY | GRAY |
| finwt.kg | 96.43 | 83.57 | 114.6 | 145.1 | 71.5 | 52.78 |
| height | 689.8 | 864.4 | 836.6 | 227.5 | 781 | 776.5 |
| width | 1253.4 | 1055.1 | 763,2 | 1240.7 | 761.4 | 500 |
| depth | 203.1 | 62.5 | 235.5 | 715.4 | 293.3 | 453.5 |
| partvol | 13709201 | 9319108 | 16235805 | 20374896 | 9108896 | 7437780 |
| risers | 0 | 0 | 0 | 0 | 2 | 0 |
| drillholes | 42 | 62 | 35 | 76 | 22 | 39 |
| spotFaceDrillHoles | 0 | 0 | 0 | 3 | 0 | 0 |
| surfarea | 2645594 | 1325145 | 2385837 | 2479172 | 1547739 | 1412496 |
| partingLinePerim | 2143.2 | 1919.5 | 1599.8 | 1956.2 | 1522.4 | 1276.6 |

4. Sourcing Analysis:

The system sourcing analysis 325 module can determine the capabilities of a supplier by the parts they currently make. This analysis is used to help the user determine which options are available to them to resource a specific part as well as understanding the current capabilities of their suppliers. FIG. 14 shows an example report for an invention sourcing analysis 375 module on a single part and its current supplier. This type of analysis can also be used to evaluate suppliers other than the current supplier.

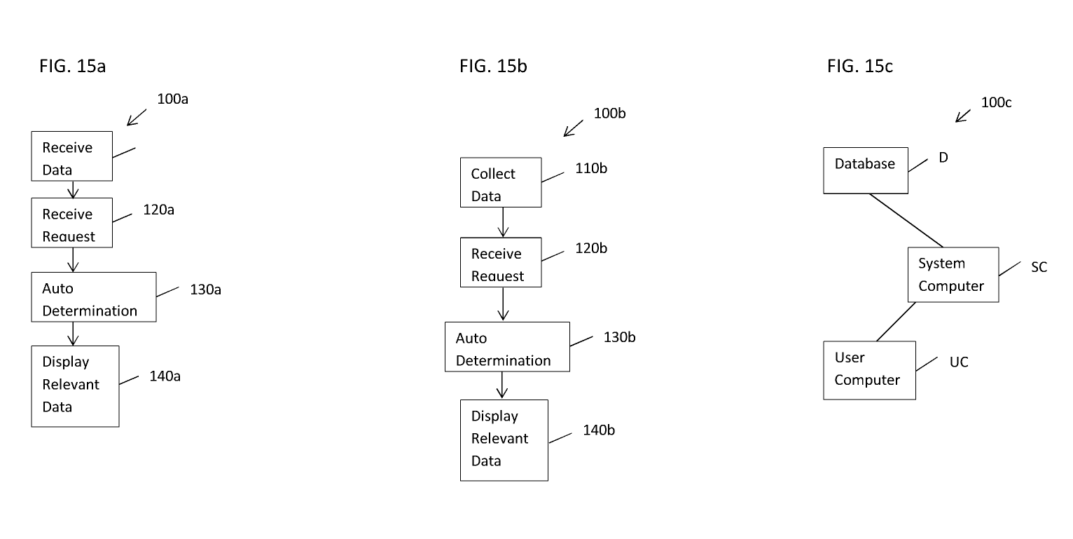

The system sourcing analysis 325 module may be configured to perform various determinations regarding current and potential suppliers and material data, such as to determine where and when particular parts and features and properties thereof are used and sourced. For example, FIG. 15a illustrates an embodiment of a method for managing cost and supply of parts according to the present disclosure. In FIG. 15a, the method 100a includes the step 110a of receiving part information for a plurality of part suppliers, where the part information for each part supplier comprises material data of parts for the part supplier. The material data can include the material specifications that contribute or wholly make up a part. For example, the material data for a fastener may be, for example, a particular type of iron or steel and a type of finish. The part information may be received in a variety of ways, such as, for example, through an electronic correspondence (e.g., e-mail) from a parts supplier or entity, through extraction of information on a CAD file, or other information transfer mechanism. After receipt, the part information may be transferred (e.g., uploaded) into a computer database. Alternatively, the part information may be received directly into the computer database.

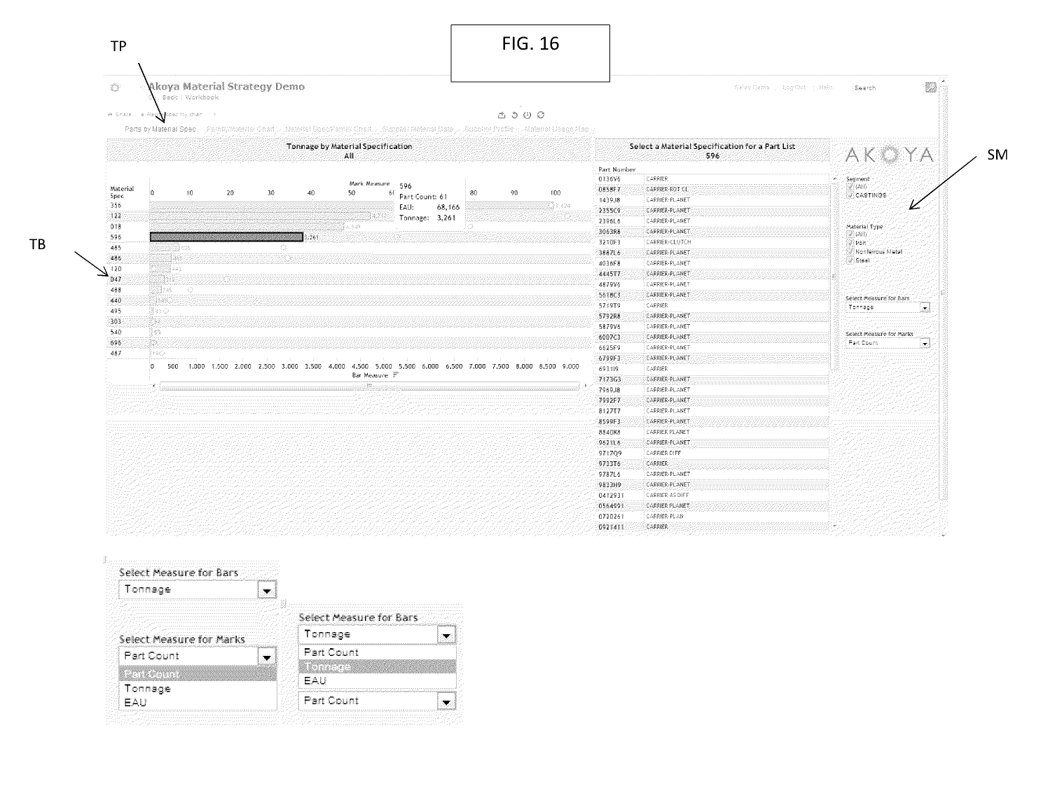

As shown in FIG. 15a, the method 100a also includes the step 120a of receiving a request involving the material data regarding the plurality of part suppliers. Such a request may include a user selecting a material type, finish, paint, heat treatment, or any other feature or property. That is, the user requests information regarding what the part suppliers offer in terms of a particular material type, finish, or other property. In FIG. 15a, the method 100a also includes the step 130a of automatically determining any relevant material data of the part information for each of the plurality of part suppliers. The automatic determination may be based on a variety of features for material data, parts, and the like. For example, a user may request a particular group of part suppliers and a part and the step 130a can automatically identify the corresponding suppliers and part. As shown in FIG. 15a, the method 100a also includes the step 140a of displaying at least a portion of the relevant material data, such as for each of the plurality of part suppliers. As described in FIGS. 16-21 below, the relevant material data may be displayed in a graphical user interface in the form of a chart, a pie chart on top of a map, and the like.

FIG. 15b illustrates another embodiment of a method for managing cost and supply of parts according to the present disclosure. In FIG. 15b, the method 100b includes the step 110b of collecting part information for one or more part buyers, where the part information for each part buyer comprises material data of parts of the part buyer. As mentioned above, material data can include the material specifications that contribute or wholly make up a part. As shown in FIG. 15b, the method 100b also includes the step 120b of receiving a request involving the material data for one or more part buyers. Such a request may include a user selecting a material type and segment. That is, the user requests information regarding what one or more part buyers has or needs in terms of a particular material type and segment. In FIG. 15b, the method 100b also includes the step 130b of automatically determining any relevant material data of the part information for the one or more part buyers. As mentioned above, the determination is triggered by the request and based on the details of the request. As shown in FIG. 15b, the method 100b also includes the step 140b of displaying at least a portion of the relevant material data for the one or more part buyers.

FIG. 15c illustrates an embodiment of a system for managing cost and supply of parts according to the present disclosure. In FIG. 15c, the system 100c includes a database D that includes part information regarding a plurality of part suppliers and/or one or more part buyers. The system 100c also includes a system computer SC and a user computer UC. While described hereinafter as separate devices, it should be noted that the system computer SC and user computer UC may be a single computer. As shown in FIG. 15c, a user may use the software from the user computer UC but the receipt of the request, automatic determination, and transfer of information for display may occur at the system computer SC. The system computer SC is operably connected to the database in order to carry out the steps of the methods described above.

The method 100a, 100b of the present disclosure may be implemented into a computer-readable medium and be carried out with the aid of a computer. A computer-readable medium, such as a non-volatile storage medium, may comprise the steps of the method described above. For instance, the method may be incorporated into a computer program to automatically determine the relevant material data and display the data. The computer program may be generated in any software language or framework such as JAVA, SQL, C#, COBOL, C++, Microsoft® .NET Framework or the like.

The computer-readable medium for performing the embodiments of the present disclosure may include computer-readable program code portions, such as a series of computer instructions, embodied in the computer-readable medium. It should be understood that the computer-readable program code portions may include separate executable portions for performing distinct functions to accomplish embodiments of the present disclosure. Additionally, or alternatively, one or more of the computer-readable program portions may include one or more executable portions for performing more than one function to thereby accomplish embodiments of the process of the present disclosure.

In conjunction with the computer-readable medium, a computer that includes a processor, such as a programmable-variety processor responsive to software instructions, a hardwired state machine, or a combination of these may be used to carryout the method disclosed above. Such computers may also include memory, which in conjunction with the processor is used to process data and store information. Such memory can include one or more types of solid state memory, magnetic memory, or optical memory, just to name a few. By way of non-limiting example, the memory can include solid state electronic random access memory (RAM); sequential access memory (SAM), such as first-in, first-out (FIFO) variety or last-in, first-out (LIFO) variety; programmable read only memory (PROM); electronically programmable read only memory (EPROM); or electronically erasable programmable read only memory (EEPROM); an optical disc memory (such as a DVD or CD-ROM); a magnetically encoded hard disc, floppy disc, tape, or cartridge media; or a combination of these memory types. In addition, the memory may be volatile, non-volatile, or a hybrid combination of volatile and non-volatile varieties. The memory may include removable memory, such as, for example, memory in the form of a non-volatile electronic memory unit; an optical memory disk (such as a DVD or CD ROM); a magnetically encoded hard disk, floppy disk, tape, or cartridge media; or a combination of these or other removable memory types. The memory may also include solid state memory, USB keys, and the like.

The computers described above may also include a display upon which information may be displayed in a manner perceptible to the user, such as, for example, a computer monitor, cathode ray tube, liquid crystal display, light emitting diode display, touchpad or touchscreen display, and/or other means known in the art for emitting a visually perceptible output. Such computers may also include one or more data entry means or devices, such as, for example, a keyboard, keypad, pointing device, mouse, touchpad, touchscreen, microphone, and/or other data entry means known in the art. Each computer also may comprise an audio display means such as one or more loudspeakers and/or other means known in the art for emitting an audibly perceptible output.

The following discussion relating to FIGS. 16-21 describes an example of a computer-readable medium that comprises the steps of the method described above. The computer program described in FIGS. 16-21 is referred to herein as the Cost & Supply Manager (CSM) tool. FIGS. 16-21 show a graphical user interface of the part supply management software showing the results of the CSM tool for various requests.

The CSM tool may be based on any development platform, such as Microsoft®.NET, Java, Microsoft® Silverlight® application. While the Microsoft® Silverlight® application may be used, any other number of development platforms may also be used. The CSM tool uses visualization techniques to make it easy for users to understand differences between suppliers and how a part buyer is currently leveraged. The CSM tool generally allows users to manage part supply without the need to analyze each and every part supplier.

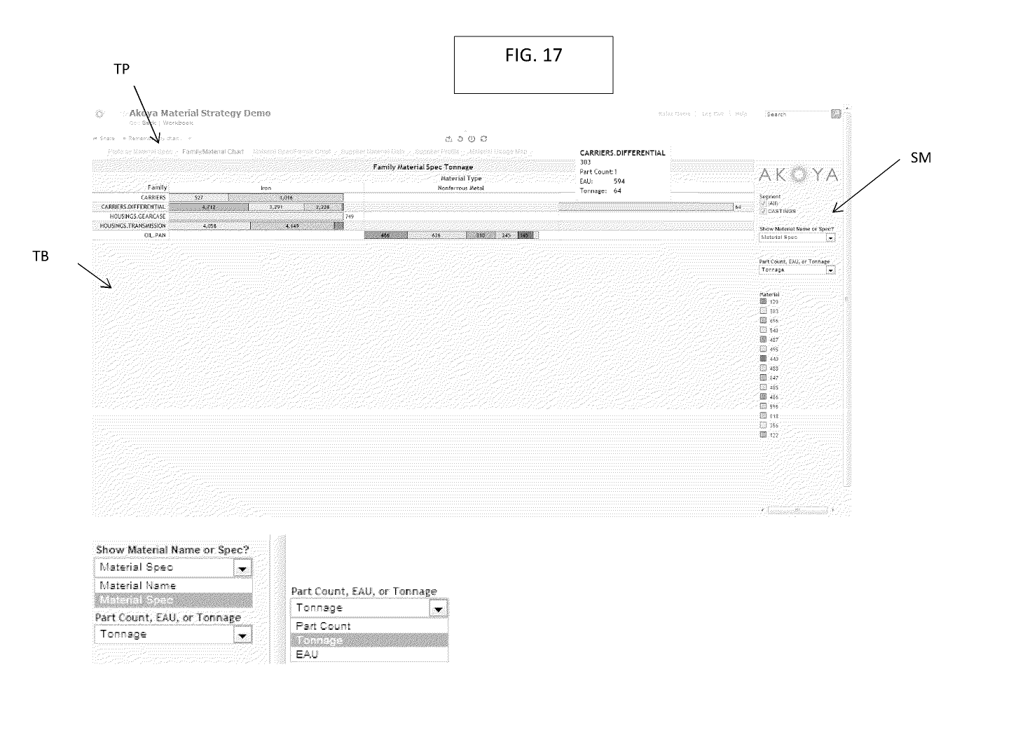

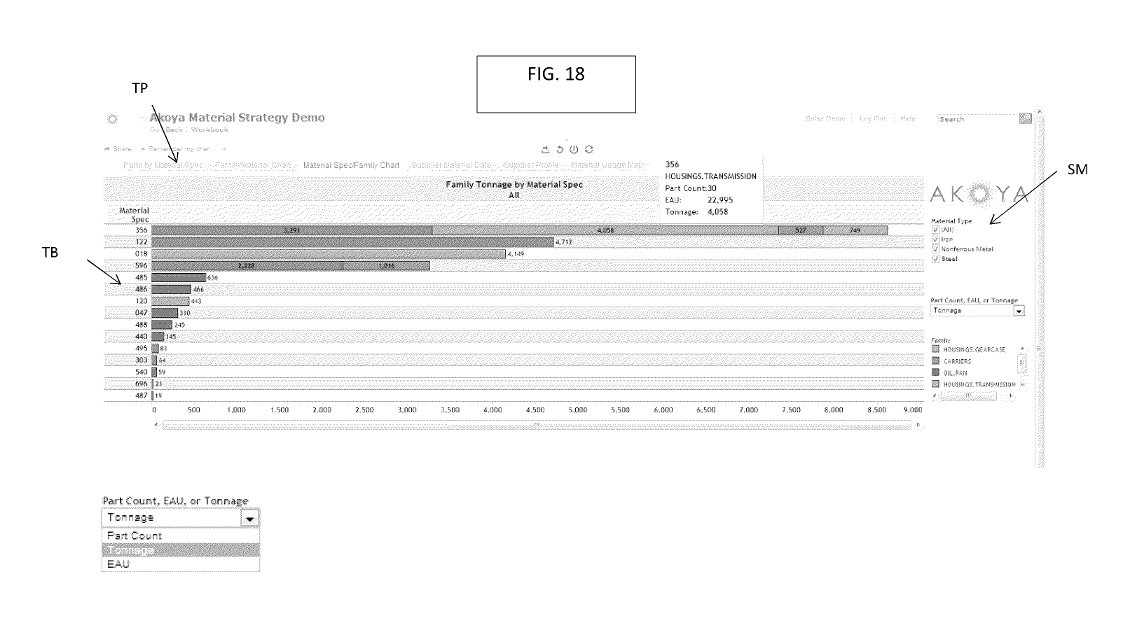

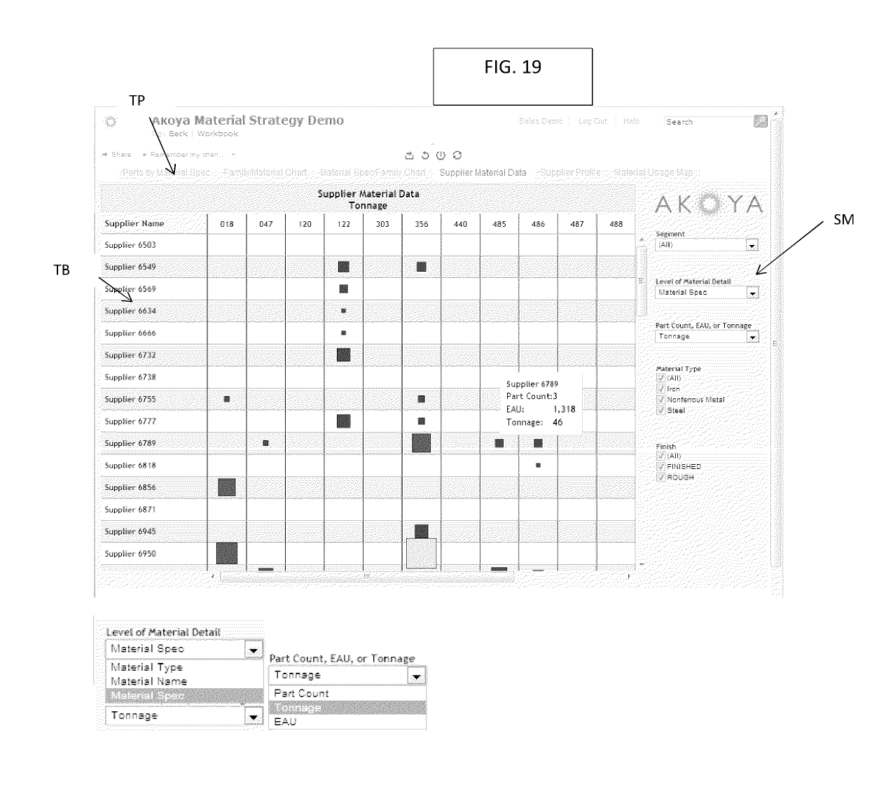

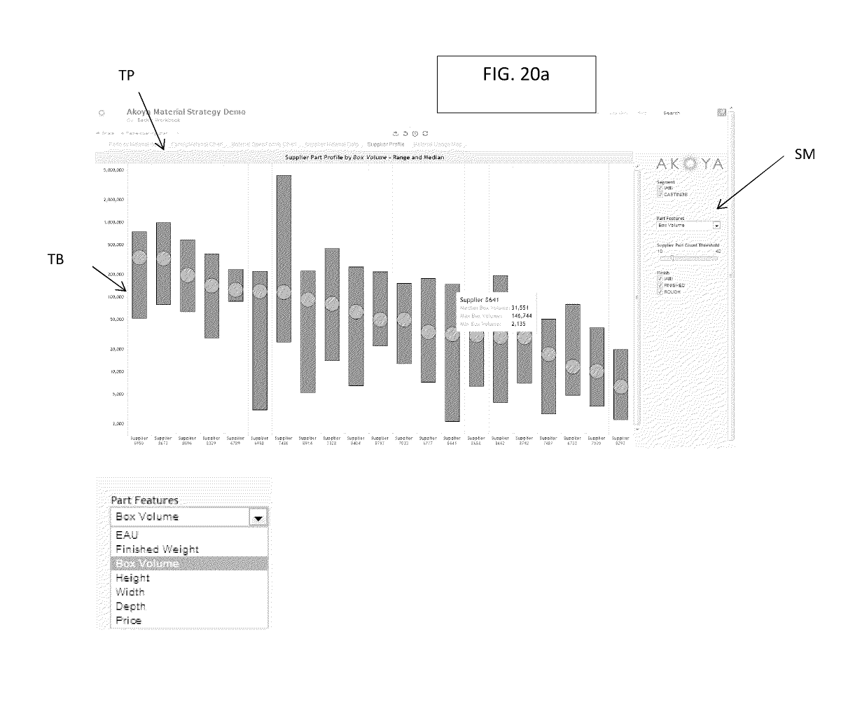

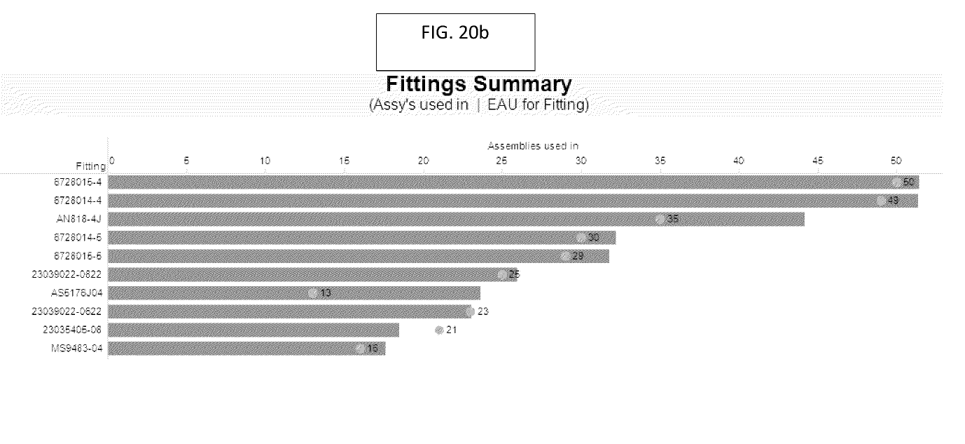

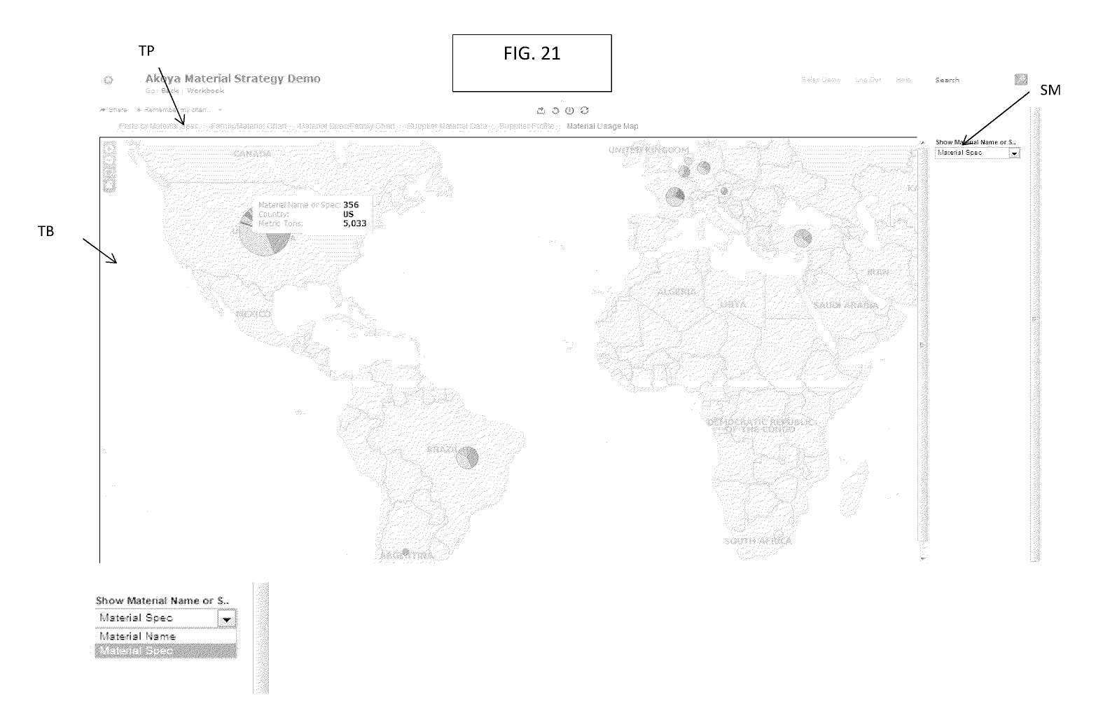

Reports generated by the CSM tool form a framework for efficient and/or opportunistic action by a company regarding parts suppliers. In general, the use of a CSM tool may help users create an action plan for choosing part suppliers based on price while mitigating or minimizing risk. For example, the CSM tool may determine material consolidation strategies for users based upon analysis of material data for one or more part buyers. Each embodiment of the CSM tool is computer-implemented. FIG. 16 shows a graphical user interface of the CSM tool according to at least one embodiment of the present disclosure. As shown in FIG. 16, the CSM tool includes a tab panel TP with several tabs. Upon selecting one of the tabs in the tab panel TP, the corresponding tab box TB is displayed. In FIG. 16, for example, the Parts by Material Spec tab is active and the corresponding data is displayed in the tab box TB. The Parts by Material Spec tab includes a measure of the amount of a material for a company and the parts of the company that include that material. In FIG. 16, the material specification 596 has been selected in the table of materials and the parts that include material specification 596 are listed. FIG. 17 shows the Family/Material Chart tab, which includes a table of the materials (and quantity thereof) that make up various parts (e.g., oil pan). FIG. 18 shows the Material Spec/Family Chart tab, which includes a table of materials and the measure of total quantity of each material for the company. Within the measure of total quantity of each material, the table shows the amount of the total that corresponds to each part. FIG. 19 shows the Supplier Material Data tab, which includes a table showing the amounts of materials that individual suppliers based on the parts that the suppliers offer. FIG. 20a shows the Supplier Profile tab, which includes a chart of supplier by box volumes. FIG. 20b shows a Supplier Material Data tab, which includes, for this example, information on what fittings for tubes are present in assemblies. Of course, the Supplier Material Data tab may provide information for any type of material, process, or part, such as, for example, paint, heat treatment, special feature, and the like. The Supplier Material Data tab can allow users to determine material usage by supplier and determine a possible material consolidation strategy to allow the supplier to order more of a single material and thus get a better purchase price. FIG. 21 shows the Material Usage Map tab, which includes a map showing the breakdown of materials from particular territories (e.g., Brazil). In FIGS. 16-21, there are 7 tabs shown in tab panel TP. There may, of course, be more or less tabs.

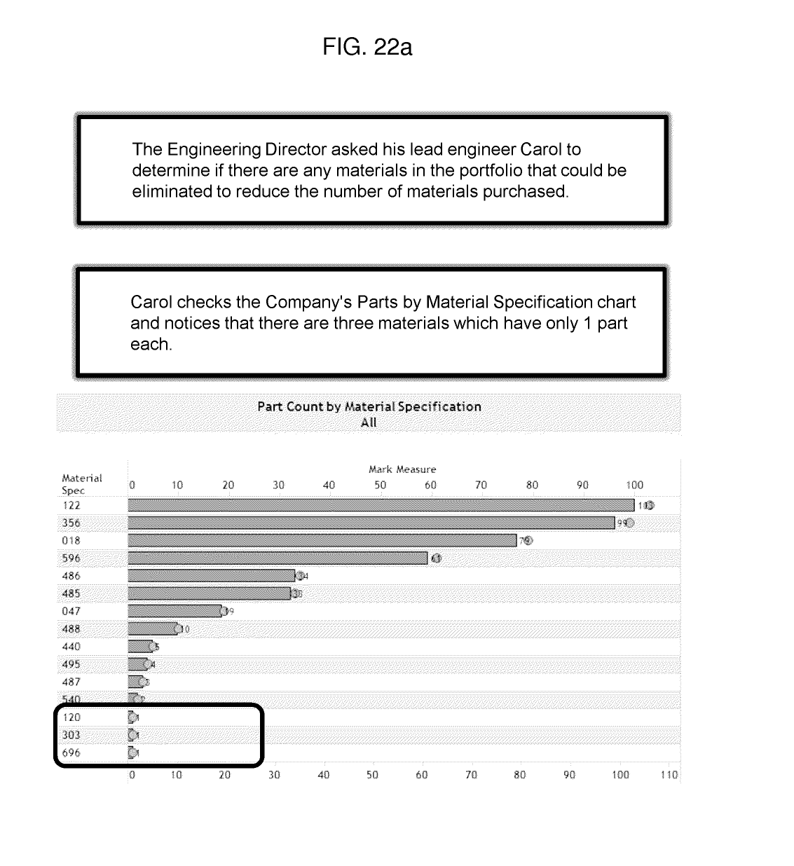

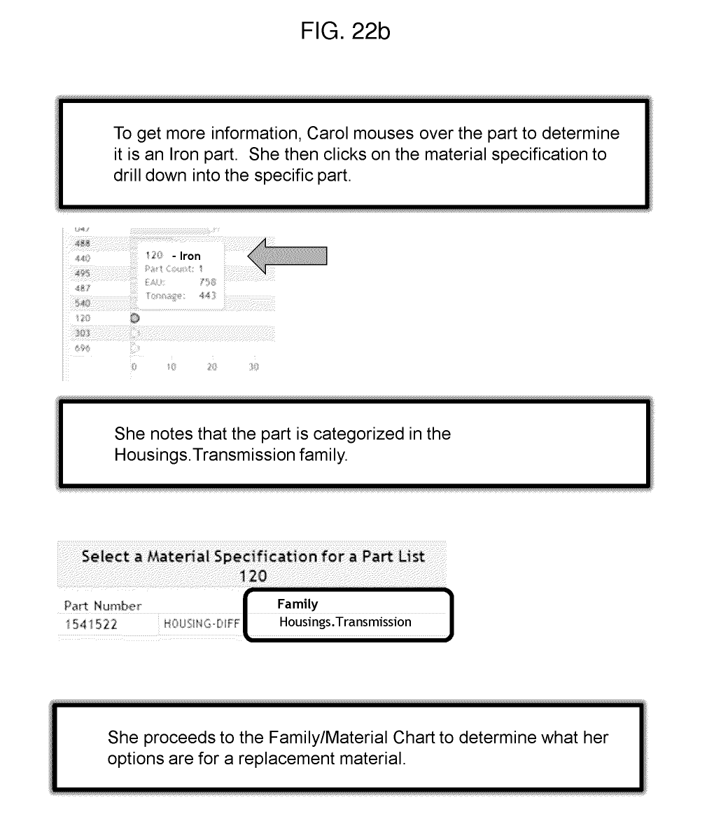

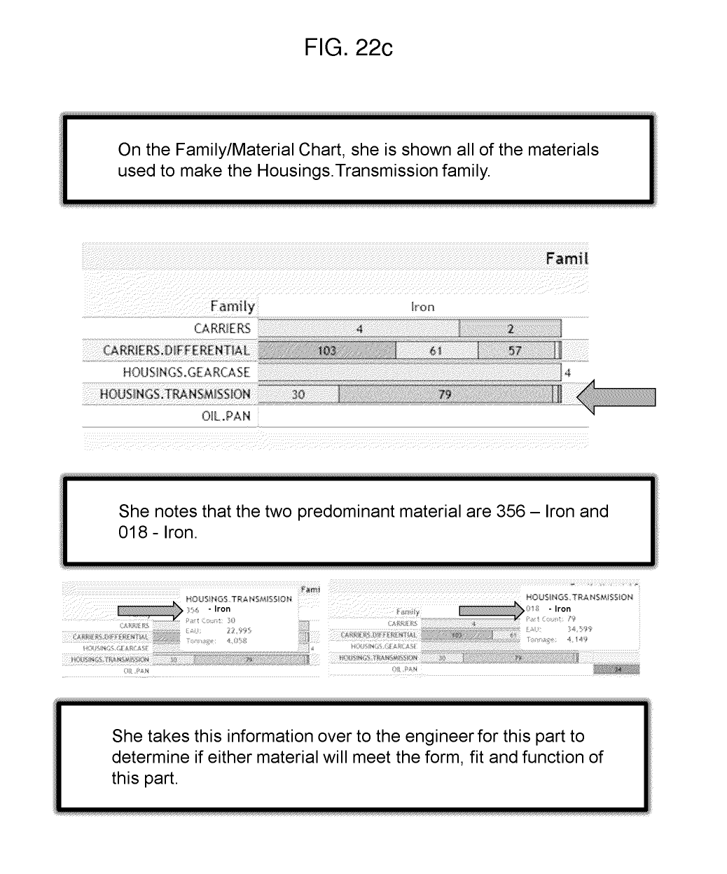

As mentioned above, FIGS. 16-18 and 21 display breakdowns of the material data for a parts buyer (e.g., a manufacturing company). The parts buyer may be able to use this information to identify materials (and suppliers) that they may be able to eliminate by using a different material and/or different supplier. For example, FIGS. 22a-22c illustrate an example of how the CSM tool may be used to eliminate materials for a company's portfolio. As described in FIG. 22a, an engineer, Carol, receives instructions to determine if any materials in the company's portfolio can be eliminated. Carol uses the CSM tool to identify three materials that are only used in one part each. In FIG. 22b, Carol puts her computer cursor over one of the displayed materials that has just one part and the CSM tool displays that Carol's selection is an iron part. Using the CSM tool, Carol is able to determine that this one part is categorized in the Housing.Transmissions family. Therefore, in FIG. 22c, Carol uses the CSM tool to identify what other materials are used to make parts in the Housing.Transmission family and whether the other materials may be used as an alternative for the part.

FIGS. 19-21 display breakdowns of the material data for a plurality of part suppliers. A parts buyer may be able to use this information to identify suppliers that present a risk for continued supply of parts, a supplier that may likely offer parts at a better rate than the buyer's current supplier, and the like. The parts buyer may also use the CSM tool to assist with new product development. For example, a parts buyer, Marcus, is designing a new transmission housing. Marcus can use the CSM tool to determine what materials are commonly used for existing transmission housings. Marcus can research these material specifications to assess which may be appropriate for the part he is designing.

While this disclosure has been described as having various embodiments, these embodiments according to the present disclosure can be further modified within the scope and spirit of this disclosure. This application is therefore intended to cover any variations, uses, or adaptations of the disclosure using its general principles. For example, any methods disclosed herein represent one possible sequence of performing the steps thereof. A practitioner may determine in a particular implementation that a plurality of steps of one or more of the disclosed methods may be combinable, or that a different sequence of steps may be employed to accomplish the same results. Each such implementation falls within the scope of the present disclosure as disclosed herein and in the appended claims. Furthermore, this application is intended to cover such departures from the present disclosure as come within known or customary practice in the art to which this disclosure pertains.

1. A computerized method of managing cost and supply of parts, the method comprising:
receiving part information for a plurality of part suppliers, wherein the part information for each part supplier comprises material data of parts;
receiving a request involving the material data of parts of the plurality of part suppliers;
automatically determining any relevant material data of parts of the plurality of part suppliers based on the request; and
displaying at least a portion of the relevant material data.

2. The method of claim 1, wherein the material data comprises at least one of type of material and type of finish.

3. The method of claim 1, wherein displaying at least a portion of the relevant material data comprises presenting an indication of an amount of a type of material contained within predetermined parts.

4. The method of claim 1, wherein receiving a request comprises receiving a selection of at least one of type of material and type of finish.

5. The method of claim 1, wherein automatically determining any relevant material data comprises identifying selected material data used by one or more of the plurality of part suppliers.

6. The method of claim 1, wherein automatically determining any relevant material data comprises identifying a selected type of material used by one or more of the plurality of part suppliers.

7. The method of claim 1, wherein displaying at least a portion of the relevant material data comprises presenting a display identifying the source of the material data based on location.

8. A computerized method of managing cost and supply of parts, the method comprising:
collecting part information for one or more part buyers, wherein the part information for each part buyer comprises material data of parts of the part buyer;
receiving a request involving the material data of the one or more part buyers;
automatically determining any relevant material data of the part information for the one or more part buyers; and
displaying at least a portion of the relevant material data for the one or more part buyers.

9. The method of claim 8, wherein collecting part information comprises extracting part information from electronic files.

10. The method of claim 8, wherein the material data comprises at least one of type of material and type of finish.

11. The method of claim 8, wherein displaying at least a portion of the relevant material data comprises presenting an indication of an amount of a type of material contained within predetermined parts.

12. The method of claim 8, wherein receiving a request comprises receiving a selection of at least one of type of material and type of finish.

13. The method of claim 8, wherein automatically determining any relevant material data comprises identifying selected material data used by one or more of the part buyers.

14. The method of claim 8, wherein automatically determining any relevant material data comprises identifying a selected type of material used by one or more of the part buyers.

15. The method of claim 8, wherein displaying at least a portion of the relevant material data comprises presenting a display identifying the source of the material data based on location.

16. A system of managing cost and supply of parts, the system comprising:
a database comprising part information for a plurality of part suppliers and one or more part buyers, wherein the part information comprises material data of parts; and
a processor operably connected to the database, wherein the processor receives requests, automatically determines any relevant material data based on the requests, and is configured to display the relevant material data on a monitor that is operably connected to the processor.

17. The system of claim 16, wherein the material data comprises at least one of type of material and type of finish.

18. The system of claim 16, wherein automatically determines any relevant material data comprises identifying selected material data used by any of the plurality of part suppliers and the one or more part buyers.

19. The system of claim 16, wherein automatically determines any relevant material data comprises identifying a selected type of material used by any of the plurality of part suppliers and the one or more part buyers.

20. The system of claim 16, wherein displays the relevant material data comprises communicating with a monitor in order to present on the monitor a display identifying the source of the material data based on location.
